(19) United States
(12) Patent Application Publication
(10) Pub. No.: US 2015/0193453 A1
(43) Pub. Date: Jul. 9, 2015

(54) METHOD AND APPARATUS FOR STORING WAVEFORM DATA

(71) Applicant: Electronics and Telecommunications Research Institute, Daejeon (KR)

(72) Inventors: Yongdae KIM, Daejeon (KR); Sang-Yun HAN, Daejeon (KR); Jong Tai LEE, Daejeon (KR); Haeng Seok KO, Daejeon (KR); Sangwoo PARK, Daejeon (KR)

(21) Appl. No.: 14/470,648

(22) Filed: Aug. 27, 2014

(30) Foreign Application Priority Data
Jan. 9, 2014 (KR) 10-2014-0002907

(51) Int. Cl. G06F 17/30

(52) U.S. Cl. CPC G06F 17/30082; G06F 17/30221

(57) ABSTRACT

A method and apparatus for storing waveform data are disclosed. The apparatus for storing waveform data includes a channel information reception unit, a folder generation unit, a file generation unit, and an analysis information control unit. The channel information reception unit receives waveform data from an external measuring device. The folder generation unit generates a high level folder for each waveform measurement unit of the waveform data, and generates low level folders, in which information of each channel is stored, for the generated corresponding high level folder. The file generation unit generates waveform data files to be stored in the low level folders. The analysis information control unit stores a text file, corresponding to analysis information necessary for subchannel analysis, in the high level folder.

### CROSS-REFERENCE TO RELATED APPLICATION

This application claims the benefit of Korean Patent Application No. 10-2014-0002907, filed Jan. 9, 2014, which is hereby incorporated by reference herein in its entirety.

### BACKGROUND OF THE INVENTION

1. Technical Field

The present invention relates to a method and an apparatus for storing waveform data and, more particularly, to a method and an apparatus for storing waveform data in connection with a subchannel analysis.

2. Description of the Related Art

A subchannel analysis technology was first known in 1999, and a large number of methods therefor have been developed up to the present time. Among them, a subchannel analysis method using a correlation coefficient is widely used.

All subchannel analysis methods, except for a simple power analysis (SPA) method, need to measure a large number of waveforms. In order to store a large amount of waveform data and use it for subchannel analysis, there are many cases where rules related to a method by which waveform data is stored are set up in advance. For example, Korean Patent Application Publication No. 10-2011-0071931 discloses a method for generating waveform information files for a subchannel analysis system, in which waveform data is generated in a waveform information file binary form so that information used to manage waveform data is organized in the form of a header field, a data field, and an additional information field.

However, when waveform data is stored in the above manner, the process of first analyzing the method by which actual data has been stored by analyzing a header, and then reading a file is required. In addition, the process of calculating actual measured data values using information, such as a voltage offset, in the header is required. If the header information is not known in advance, the stored waveforms cannot be used in subchannel analysis even when the waveform data is present.

Although the conventional technology is advantageous in an environment in which a system for analyzing a stored waveform information file and converting the file into actual values is present, a program capable of analyzing file information should be developed when stored waveform information files are distributed to third party organizations. Therefore, a disadvantage arises in that a workload inefficiently increases during subchannel analysis from the perspective of a user.

### SUMMARY OF THE INVENTION

Accordingly, at least one embodiment of the present invention is intended to provide a method and apparatus for storing waveform data in connection with a subchannel analysis.

In accordance with an aspect of the present invention, there is provided a method for storing waveform data, including receiving, by an apparatus for storing waveform data, waveform data; generating a high level folder for each waveform measurement unit of the waveform data, and generating low level folders, in which information of each channel is stored, for the generated corresponding high level folder; generating waveform data files to be stored in the low level folders; and

storing a text file, corresponding to analysis information necessary for subchannel analysis, in the high level folder.

Receiving the waveform data may include receiving waveform data corresponding to the information of individual measuring channels of an oscilloscope.

The high level folder may be generated using the date and time when the waveform data has been obtained from a test.

Generating the low level folders may include generating a set number of low level folders in which information of each channel is stored.

Generating the waveform data files may include generating waveform data file including time and voltage values.

The analysis information may correspond to the values of plain text and coded text; and storing the text file in the high level folder may include storing the values of the plain text and the coded text as a Hex-type text file.

In accordance with another aspect of the present invention, there is provided an apparatus for storing waveform data, including a channel information reception unit configured to receive waveform data from an external measuring device; a folder generation unit configured to generate a high level folder for each waveform measurement unit of the waveform data, and to generate low level folders, in which information of each channel is stored, for the generated corresponding high level folder; a file generation unit configured to generate waveform data files to be stored in the low level folders; and an analysis information control unit configured to store a text file, corresponding to analysis information necessary for subchannel analysis, in the high level folder.

The channel information reception unit may receive waveform data corresponding to the information of the individual measuring channels of the external measuring device.

The folder generation unit may generate the high level folder using the date and time when the waveform data has been obtained from a test.

The folder generation unit may generate a set number of low level folders in which information of each channel is stored.

The file generation unit may generate waveform data files including time and voltage values.

The analysis information control unit may store the values of plain text and coded text corresponding to the analysis information as a Hex-type text file.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram schematically illustrating the configuration of an apparatus for storing waveform data according to an embodiment of the present invention;

FIG. 2 is a reference diagram applied to the apparatus for storing waveform data according to the embodiment of the present invention;

FIG. 3 is a diagram illustrating an example of a store data input/output file according to an embodiment of the present invention; and

FIG. 4 is a flowchart illustrating a method of storing waveform data according to an embodiment of the present invention.

### DESCRIPTION OF THE PREFERRED EMBODIMENTS

The present invention is described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clear.

A method and apparatus for storing waveform data are described below with reference to the accompanying drawings.

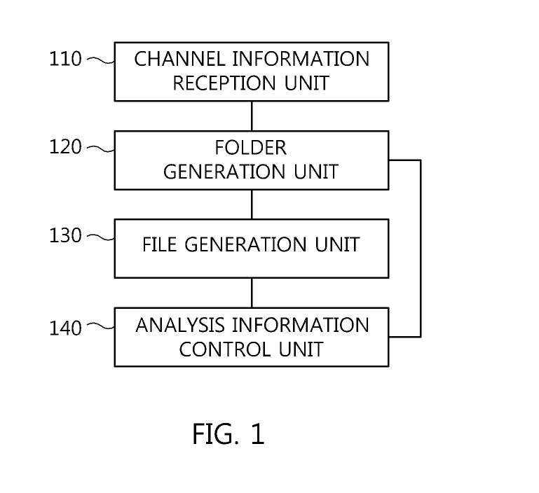

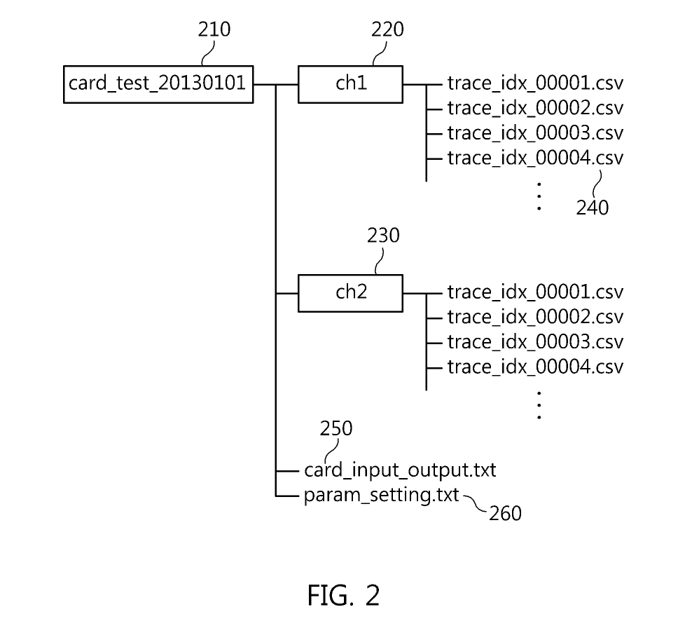

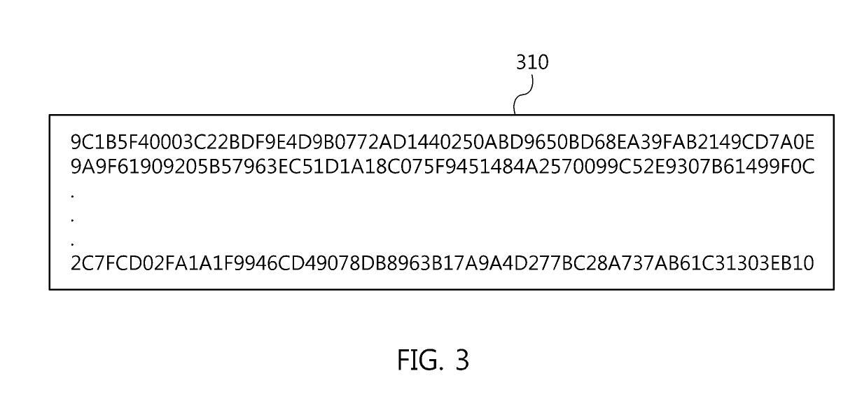

FIG. 1 is a schematic diagram illustrating the configuration of an apparatus for storing waveform data according to an embodiment of the present invention. FIG. 2 is a reference diagram applied to the apparatus for storing waveform data according to the embodiment of the present invention. FIG. 3 is a diagram illustrating an example of a store data input/output file according to an embodiment of the present invention.

Referring to FIG. 1, the apparatus for storing waveform data includes a channel information reception unit 110, a folder generation unit 120, a file generation unit 130, and an analysis information control unit 140.

The channel information reception unit 110 receives the information of channels corresponding to the respective measuring channels of an external oscilloscope, that is, waveform data measured by the oscilloscope.

The folder generation unit 120 generates a high level folder for each waveform data measurement unit of the waveform data received by the channel information reception unit 110, and generates low level folders, in which the information of each channel is stored, for each generated high level folder.

Referring to FIG. 2, the folder generation unit 120 generates a high level folder 210 using the date and time when the waveform data measured by the oscilloscope has been obtained from a test. That is, since the high level folder 210 is generated using the date and time when the test has been conducted, generated high level folders are distinguished from each other.

The folder generation unit 120 may generate a set number of low level folders, in which the information of each channel is stored, for each high level folder 210. As illustrated in FIG. 2, the folder generation unit 120 may generate two low level folders, and may generate a number of low level folders, up to and including four, depending upon the oscilloscope.

The file generation unit 130 generates waveform data files to be stored in the low level folders generated by the folder generation unit 120. In this case, the waveform data files include numerals to facilitate the distinguishing of waveforms from each other, as illustrated in 240 of FIG. 2. Furthermore, the waveform data files are divided by commas “,” and include the time and measured values (voltages). For example, when 500 waveforms are obtained from channel 1, 500 waveform data files (see 240 of FIG. 2) are stored in the lower level folder (see 220 of FIG. 2) corresponding to channel 1.

The analysis information control unit 140 stores analysis information necessary for subchannel analysis, for example, a text file corresponding to the values of plain text and coded text, in the high level folder 210. In this case, the analysis information control unit 140 stores the values of the plain text and the coded text in the form of a Hex-type text file (see 250 of FIG. 2).

The Hex-type text file includes input data values and output data values in one line, as illustrated in FIG. 3. For example, when 16-byte data (e.g., plain text) is input and 16-byte data (e.g., coded text) is output, a corresponding text file includes 32-byte data.

Furthermore, the analysis information control unit 140 stores and manages all the set values of the oscilloscope, which has transferred the waveform data, as a text file (see 260 of FIG. 2). Therefore, according to the present invention, since all the set values of the oscilloscope are stored and managed as a text file, it is possible to later determine the set values at which the oscilloscope obtained the waveform data and to obtain the waveform data under the same experimental conditions again.

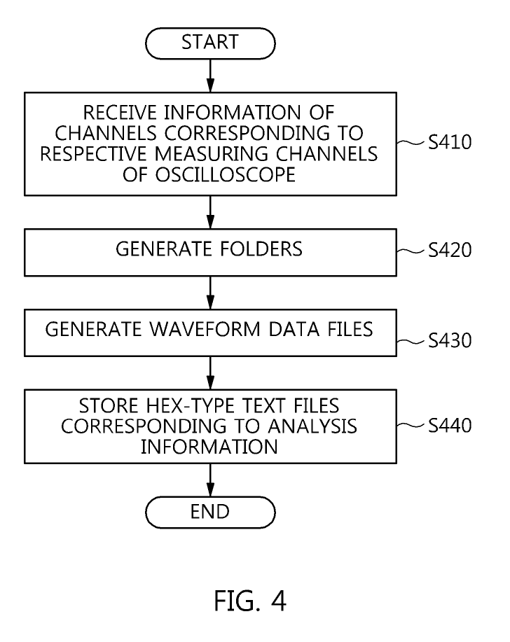

Next, a method of storing waveform data is described with reference to FIG. 4.

FIG. 4 is a flowchart illustrating a method of storing waveform data according to an embodiment of the present invention.

Referring to FIG. 4, the apparatus for storing waveform data receives the information of channels corresponding to the respective measuring channels of an external oscilloscope, that is, waveform data measured by the oscilloscope, at step S410.

The apparatus for storing waveform data generates a high level folder for each waveform data measurement unit of the waveform data received by the channel information reception unit 110 at step S410, and generates a set number of low level folders, in which the information of each channel is stored, for the generated high level folder at step S420.

In more detail, the apparatus for storing waveform data generates the high level folder 210 using the date and time when the waveform data received at step S410 has been obtained from a test. That is, since the high level folder 210 is generated using the date and time when the test has been conducted, generated high level folders are distinguished from each other.

In addition, the apparatus for storing waveform data may generate a set number of low level folders, in which the information of each channel is stored, for each high level folder 210. As illustrated in FIG. 2, the apparatus for storing waveform data may generate two low level folders, and may generate a number of low level folders, up to and including four, depending upon the oscilloscope.

The apparatus for storing waveform data generates waveform data files to be stored in the low level folders generated at step S420. In this case, the waveform data files include numerals to facilitate the distinguishing of waveforms from each other, as illustrated in 240 of FIG. 2. Furthermore, the waveform data files are divided by commas “,” and include the time and measured values (voltages). For example, when 500 waveforms are obtained from channel 1, 500 waveform data files (see 240 of FIG. 2) are stored in the lower level folder (see 220 of FIG. 2) corresponding to channel 1.

The apparatus for storing waveform data stores analysis information necessary for subchannel analysis, for example, a text file corresponding to the values of plain text and coded text, in the high level folder 210. In this case, the apparatus for storing waveform data stores the values of the plain text and the coded text in the form of a Hex-type text file (see 250 of FIG. 2).

The Hex-type text file includes input data values and output data values in one line, as illustrated in FIG. 3. For example, when 16-byte data (e.g., plain text) is input and 16-byte data (e.g., coded text) is output, a corresponding text file includes 32-byte data.

Furthermore, the apparatus for storing waveform data stores and manages all the set values of the oscilloscope, which has transferred the waveform data, as a text file (see 260 of FIG. 2). Therefore, according to the present invention, since all the set values of the oscilloscope are stored and managed as a text file, it is possible to later determine the set values at which the oscilloscope obtained the waveform data and to obtain the waveform data under the same experimental conditions again.

According to at least one embodiment of the present invention, the method and apparatus for storing waveform data can use waveform data using a function of reading a text file without converting waveform data using a conversion tool, thereby increasing the efficiency of the process of reading waveforms in connection with subchannel analysis.

Although the preferred embodiments of the present invention have been disclosed for illustrative purposes, those skilled in the art will appreciate that various modifications, additions and substitutions are possible without departing from the scope and spirit of the invention as disclosed in the accompanying claims.

What is claimed is:

1. A method for storing waveform data, comprising:
receiving, by an apparatus for storing waveform data, waveform data;
generating a high level folder for each waveform measurement unit of the waveform data, and generating low level folders, in which information of each channel is stored, for the generated corresponding high level folder;
generating waveform data files to be stored in the low level folders; and
storing a text file, corresponding to analysis information necessary for subchannel analysis, in the high level folder.

2. The method of claim 1, wherein receiving the waveform data comprises receiving waveform data corresponding to information of individual measuring channels of an oscilloscope.

3. The method of claim 1, wherein the high level folder is generated using a date and time when the waveform data has been obtained from a test.

4. The method of claim 1, wherein generating the low level folders comprises generating a set number of low level folders in which information of each channel is stored.

5. The method of claim 1, wherein generating the waveform data files comprises generating waveform data file including time and voltage values.

6. The method of claim 1, wherein:
the analysis information corresponds to values of plain text and coded text; and
storing the text file in the high level folder comprises storing the values of the plain text and the coded text as a Hex-type text file.

7. An apparatus for storing waveform data, comprising:
a channel information reception unit configured to receive waveform data from an external measuring device;
a folder generation unit configured to generate a high level folder for each waveform measurement unit of the waveform data, and to generate low level folders, in which information of each channel is stored, for the generated corresponding high level folder;
a file generation unit configured to generate waveform data files to be stored in the low level folders; and
an analysis information control unit configured to store a text file, corresponding to analysis information necessary for subchannel analysis, in the high level folder.

8. The apparatus of claim 7, wherein the channel information reception unit receives waveform data corresponding to information of individual measuring channels of the external measuring device.

9. The apparatus of claim 7, wherein the folder generation unit generates the high level folder using a date and time when the waveform data has been obtained from a test.

10. The apparatus of claim 7, wherein the folder generation unit generates a set number of low level folders in which information of each channel is stored.

11. The apparatus of claim 7, wherein the file generation unit generates waveform data files including time and voltage values.

12. The apparatus of claim 7, wherein the analysis information control unit stores values of plain text and coded text corresponding to the analysis information as a Hex-type text file.
